(19) United States
(12) Patent Application Publication
(10) Pub. No.: US 2006/0084446 A1
(43) Pub. Date: Apr. 20, 2006

(54) Mobile station with a plurality of interfaces

(75) Inventor: Hans-Jorgen Henriksson, Stockholm (SE)

Correspondence Address: PILLSBURY WINTHROP SHAW PITTMAN, LLP, P.O. BOX 10500, MCLEAN, VA, 22102, US

(73) Assignee: Wm2M Communication AB, Bromma (SE)

(21) Appl. No.: 11/282,592

(22) Filed: Nov. 21, 2005

Related U.S. Application Data
(63) Continuation of application No. 09/936,761, filed on May 1, 2002.

(30) Foreign Application Priority Data
Mar. 16, 1999 (SE) 9900954-0

(51) Int. Cl. H04Q 7/20

(52) U.S. Cl. 455/456.1; 455/557

(57) ABSTRACT

A method and a mobile station, in which the CPU memory of the mobile station provides interfaces for a plurality of applications that are external to the mobile station. Applications program modules for the external applications are stored in that part of the CPU memory of a mobile station which is available after that the software than controls the conventional functions of the mobile station has been stored. The CPU of the mobile station thereafter performs the functions that connect external devices to the radio part of the mobile station and in this way replaces a conventional external CPU as interface between external devices and the mobile station.

### CROSS REFERENCE TO RELATED APPLICATIONS

This application is a continuation of U.S. application Ser. No. 09/936,761, filed May 1, 2002, which was the National Phase of International Application PCT/SE00/00513, filed Mar. 16, 2000, which claimed priority to Swedish Application 9900954-0, filed Mar. 16, 1999, the entire contents of all of which are incorporated by reference herein in their entirety.

### BACKGROUND OF THE INVENTION

1. Field of the Invention

The present invention concerns a method for using the CPU-memory of a mobile station as interfaces for a plurality of applications that are external to the mobile station and for the mobile station per se.

2. Description of the Related Art

Practically everyone today owns a mobile telephone. As such telephones have become available for the general public more and more applications have been established for them. Among other things, they are used for determining the position of vehicles using GPS (Global Positioning System), navigation using the said positioning system, sending of measured values from, for example, an electrical meter to a central computer, generation of a personal alarm and alarm for the theft of vehicles, often in combination with GPS, and for other monitoring tasks, such as the reading of parameters for electrical equipment in, for 1 9 example, domiciles, etc. The problem with current mobile telephones when used for such external tasks is that the external equipment must be connected to the mobile telephone via an interface in the form of a microprocessor, which adapts input and output data to the radio section of the mobile telephone. This involves additional cost and is disadvantageous for the customer and the manufacturers of the external systems, who must adapt the mobile telephones to their specific systems, such as GPS.

It would be an advantage if the customers themselves could determine what their mobile telephones are to be used for, in addition to pure radio-telephony, when purchasing them. The customer may even desire to add external applications at a later date, or even remove existing applications. This is, however, not possible with current mobile telephones, which is why there exists a need to be able to introduce applications into mobile telephones without external interfaces for adaptation to the radio section of the telephone.

The German patent application DE-A1-44 21 508 specifies a system in which the SIM-card (Subscriber Identity Module Card) of a telephone, called in German “Chip-karte” with an IC-circuit that denotes the active components of the card, can be equipped with a digital-analogue converter. A SIM-card includes an IC-circuit with a processor, that is, it is an active card. The system according, to DE-A 1-44 21 508, has thus an extra processor interface between the CPU of the mobile telephone and the external application, which in this case is a system for requesting help for the driver and passengers in a car.

The British patent application GB-A-2 289 555 specifies a “notebook” computer with a memory unit that does not use the free memory in the CPU of the notebook. Part of the application and word processor programs of the notebook computer are stored in the memory unit. The notebook computer does not communicate externally with devices that lack an external processor as an interface, with the exception of devices that do not require their own processor, with applications software included in the CPU memory of a mobile station.

### SUMMARY OF THE INVENTION

The present invention relates to a method and a mobile station for the use of the CPU memory of a mobile station as interface for a plurality of applications that are external to the mobile station according to the attached independent claims and further embodiments according to the attached dependent claims.

One intention of the present invention is to specify a mobile station that has been customized for communication with units that are external to the mobile station directly from the CPU, without using an external CPU as interface for the communication.

In particular, the invention specifies a method for using the CPU memory of a mobile station as interface for a plurality of applications that are external to the mobile station. Program modules for the said external applications are stored in that part of the CPU memory of the mobile station that is available after that the software that controls the conventional functions of the mobile station has been stored. The CPU of the mobile station thus performs those functions that connect external devices to the radio section of the mobile station and thus replaces a conventional external CPU as interface between external devices and the mobile station.

In one embodiment of the invention the input and output ports of the mobile station are connected directly to the input- and output ports of the external device, via cable or in a wireless manner, whereby the mobile station is not continuously locked into an external device.

In another embodiment the CPU has an interface to each external device and its application.

A further embodiment of the invention includes the case in which one of the external devices is a position-determining device, for determining the position of the mobile station.

Another embodiment includes the case in which one of the external devices is a measuring device for measurement of at least one measurable parameter.

A further embodiment includes the case in which one of the external devices is a navigation device for navigation of a vehicle or person.

Furthermore, the invention in one embodiment includes the case in which one of the external organs is an alarm for generating an alarm concerning a condition that requires an alarm.

A further embodiment includes the case in which one of the external devices is a monitoring device for, for example, machines or a machine park.

A further embodiment includes the case in which the external organs are customized with customized applications program modules, whereby they have been determined by the user of a mobile telephone and programmed in during ordering of the mobile station, and whereby tailoring of the mobile station is achieved according to the needs of the customer.

Furthermore, the applications program modules of the external devices can be erased and replaced by new applications program modules that are specific for the customer by reprogramming of free modules in an embodiment of the invention.

Furthermore, the present invention specifies a mobile station with its own CPU memory as interface to a plurality of applications that are external to the mobile station. The mobile station in this case includes:

program modules in the CPU memory for the said external applications, which are stored in that part of the CPU memory of the mobile station that is available after that the software that controls the conventional functions of the mobile station has been stored; and

that the CPU performs those functions that connect external devices to the radio section of the mobile station and thus replaces a conventional external CPU as interface between external devices and the mobile station.

Further, the mobile station can, according to the present invention, perform those embodiments that are specified in the method described above.

### BRIEF DESCRIPTION OF THE DRAWINGS

Henceforth reference is had to the attached drawings and the explanatory text in order to obtain a better understanding of the invention and its embodiments, whereby:

FIG. 1 illustrates schematically an embodiment of previously known technology concerning an example using GPS positioning; and

FIG. 2 illustrates schematically an embodiment according to the present invention with the example shown in FIG. 1.

### DETAILED DESCRIPTION

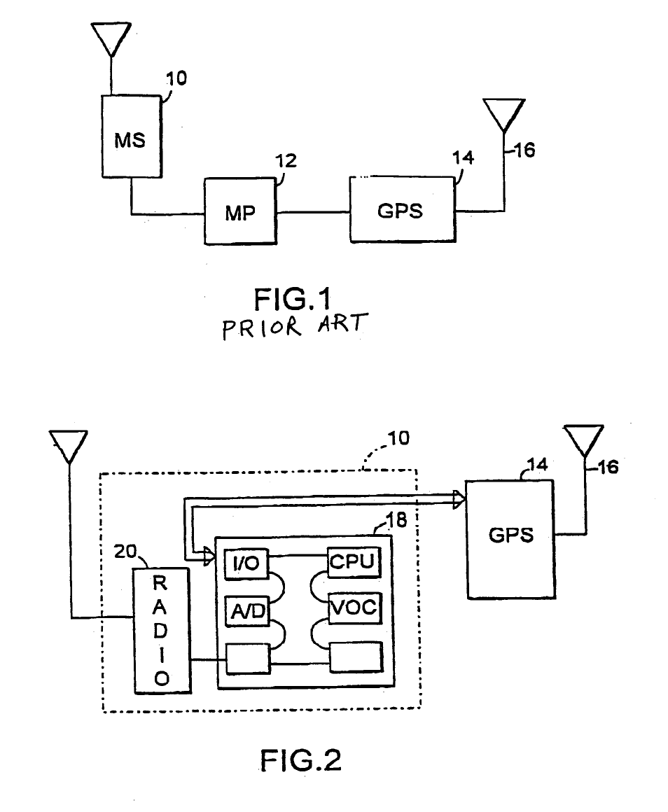

Preferred embodiments of the described invention The invention according to the present description is intended to solve the problems related to interfaces for the use of external devices, such as GPS devices, alarm devices, monitoring devices, measurement devices, etc., that make use of a mobile telephone in order to send messages to a central or similar. A previously known system is illustrated in FIG. 1 for the positioning of, for example, a vehicle, animal or person. FIG. 1 illustrates schematically an embodiment of previously known technology concerning an example using GPS positioning The system consists of a mobile station (MS) 10 that sends messages concerning the position of the bearer of the system using position information that is obtained through a GPS satellite receiver 14 with a receiving aerial 16.

In order to be able to use the mobile station 10 for radio messages, via, for example, GSM, about the position of a bearer of the same, the GPS receiver must have an interface in the form of a microprocessor 12 to the radio section of the MS 10, so that data from GPS are correctly transmitted over GSM.

FIG. 2 illustrates schematically an embodiment according to the present invention of the GSM example shown in FIG. 1.

With reference to FIG. 2 according to the present invention, the problem concerning, an extra microprocessor 12 between an external device 14 and the MS 10 is solved using the insight that the CPU (Central Processor Unit) of MS 10 should be most suitable to be used as interface between external devices 14 and the radio section 20 of MS 10. The problem is solved by using the internal memory of about 1 MB of the CPU, approximately 700 KB of which are used for the telephony and/or data part of MS 10. The invention in itself is not limited concerning the size of the memory.

Most external applications according to the above require around 50 KB of memory in order to be able to serve as applications program modules, that is, computer programs that function as interfaces between the radio section 20 of MS 10 and external devices 14.

In theory, 300 KB provides space for six applications program modules.

During, manufacture of MS 10 according to the present invention, an IC circuit 18 from, for example, the company Commquest® be used. The circuit consists of a number of modules, in this case six, whereby one module provides a CPU that can be programmed for mobile telephony. Further, one module provides an 1/0 interface for communication with the surroundings of MS 10. A further applications program module denoted VOC (VOice Coder) provides the voice coder of the mobile telephone. One module is denoted A/D and provides an analogue/digital converter.

FIG. 2 also shows two extra modules without description, which can be used as applications program modules for external devices. The one module here is, schematically shown, connected to the radio part 20 of MS 10 in order to report the position of MS 10 to a central.

According to the present invention, the problem concerning an extra microprocessor 12 between the radio section 20 of MS 10 and external devices 14 is solved such that the input- and output ports of the mobile station can be connected directly to the input- and output ports (not shown) of the device 14. In the same way can the CPU of MS 10 have an interface to each external device and its application as long as available memory capacity in MS 10 allows this.

Furthermore, certain preferred embodiments of the present invention consist of that one of the external devices is a position-determining device 14 in order to determine the position of the mobile station 10, measurement devices for measurement of at least one measurable parameter, navigation devices for the navigation of a vehicle or a person, alarms for generating an alarm concerning a condition that requires an alarm, monitoring devices for monitoring, etc. For example, the measuring device may consist of a reader of the electricity consumption of a domicile, whereby MS 10 transmits the reading to an electrical distributor.

The alarm may be an intrusion alarm with motion detector that transmits via MS 10 to an alarm central, for example, the police, in the event of an intrusion. The monitoring device may, for example, monitor the functioning of a machine or machine park in order to send messages concerning the settings of various parameters of these, and for further transmission of the parameters to a operations centre via MS 10. According to the same method, the navigation device can be used in order to specify the course information of a vehicle on a display.

The present invention is not in any way limited by the specified applications, rather a plurality of other applications that require transmission by MS 10 are possible.

The external devices 14 have hereby been achieved as specific for a customer, with customized applications, whereby they have preferably been determined and ordered by a user of MS 10, and thus programmed in during ordering of the mobile station. Tailoring of MS 10 has in this way been achieved according to the needs of the user. The applications of the external devices can even be deleted in the CPU, and replaced by new customer-specific applications program modules by programming of the available or deleted space.

The mobile station MS 10 according to the present invention with its own CPU memory as interface 18 for a plurality of applications that are external to the mobile station includes in addition to telephony and/or computer functions that are customary for MS 10 also:

Application program modules 18 in the CPU memory for the said external applications, which are stored in that part of the CPU memory of the mobile station that is available after that the software that controls the conventional functions of the mobile stations has been stored; and that the CPU performs those function that connect external devices 14 to the radio section 20 of the mobile station, and thus replaces the conventional external CPU 12 as interface 18 between the external device 14 and the mobile station 10.

The CPU in one embodiment is an IC circuit 18 that includes a fixed number of modules for external applications.

The invention also allows that the mobile telephone is connected by wire or in a wireless manner via interface 18 to different external devices as required for measurement, alarm, monitoring, navigation, positioning, etc., depending on the applications program modules, which means that MS 10 does not need to be continuously locked to one external device. In this way, the area of application of MS 10 becomes very versatile and flexible. As previously discussed, a user can then use MS 10 as a mobile telephone, electrical meter reader, navigation aid, etc., without locking its use.

The present invention has been described by the use of preferred embodiments and examples, but is not limited to these because of this. It is rather the attached claims that specify further embodiments for one skilled in this technical field.

What is claimed is:

1. A method for using a CPU memory of a mobile station as an interface for a plurality of applications that are external to the mobile station, wherein applications program modules for the external applications are stored in a part of the CPU memory of a mobile station that is available after software that controls conventional functions of the mobile station has been stored, whereby the CPU of the mobile station performs those functions that connect external devices to the radio section of the mobile station and in this way replaces a conventional external CPU as the interface between the external devices and the mobile station.

2. A method according to claim 1, wherein input and output ports of the mobile station are connected directly to input and output ports of the external device by cables or in a wireless manner, whereby the mobile station is not continuously locked to the external device.

3. A method according to claim 1, wherein the CPU has an interface to each external device and its application.

4. A method according to claim 1, wherein one of the external devices is a position-determining device for determining the position of the mobile station.

5. A method according to claim 1, wherein one of the external devices is a measurement device for measurement of at least one measurable parameter.

6. A method according to claim 1, wherein one of the external devices is a navigation device for navigation of a vehicle or person.

7. A method according to claim 1, wherein one of the external devices is an alarm for generating an alarm in a situation that requires an alarm.

8. A method according to claim 1, wherein one of the external devices is a monitoring device for monitoring conditions.

9. A method according to claim 1, wherein the external devices are specific to a customer with customized applications program modules, whereby the customized applications program modules have been determined by the customer and programmed in during ordering of the mobile station, and whereby tailoring of the mobile station is achieved according to the requirements of the customer.

10. A method according to claim 9, wherein the applications program modules of the external devices can be erased and replaced by new applications program modules specific for the customer by reprogramming free modules.

11. A method according to claim 1, wherein the CPU is an IC circuit that includes a fixed number of modules for the external applications.

12. A mobile station with a CPU memory as an interface to a plurality of applications that are external to the mobile station, comprising:
applications program modules storable in the CPU memory for the external applications, which are stored in a part of the CPU memory of the mobile station that is available after software that controls conventional functions of the mobile station has been stored and the CPU performs those functions that connect external devices to a radio section of the mobile station and, in this way, the CPU replaces a conventional external CPU as an interface between the external devices and the mobile station.

13. A mobile station according to claim 12, wherein input and output ports of the mobile station are connected directly to input and output ports of the external device by cables or in a wireless manner, whereby the mobile station is not continuously locked to the external devices.

14. A mobile station according to claim 12, wherein the CPU has an interface to each external device and its application.

15. A mobile station according to claim 12, wherein one of the external devices is a position-determining device for determining the position of the mobile station.

16. A mobile station according to claim 12, wherein one of the external devices is a measurement device for measurement of at least one measurable parameter.

17. A mobile station according to claim 12, wherein one of the external devices is a navigation device for navigation of a vehicle or person.

18. A mobile station according to claim 12, wherein one of the external devices is an alarm for generating an alarm in a situation that requires an alarm.

19. A mobile station according to claim 12, wherein one of the external devices is a monitoring device for monitoring conditions.

20. A mobile station according to claim 12, wherein the external devices are specific to the customer with customized applications program modules, whereby the customized applications program modules have been determined by the customer and programmed in during ordering of the mobile station, and whereby tailoring of the mobile station is achieved according to the requirements of the customer.

21. A mobile station according to claim 20, wherein the applications program modules of the external devices can be deleted and replaced by new applications program modules specific for the customer by reprogramming free modules.

22. A mobile station according to claim 12, wherein the CPU is an IC circuit that includes a fixed number of modules for the external applications.

23. In a mobile station having a radio section for sending messages, a CPU and a CPU memory for controlling the function of the mobile station, and a first I/O port for connection to external devices, a method for using the CPU memory as an interface for a plurality of applications external to the mobile station and for the mobile station, the method comprising:
storing an application program in a CPU memory module that is available after software that controls conventional functions of the mobile station has been stored;
controlling functions of the radio section by means of the CPU; and
performing functions that connect the external device to the radio section by means of the CPU.

24. A method for using a mobile station comprising a CPU, a CPU memory and a radio portion, the method comprising:
storing a first instruction set in the CPU memory, wherein the first instruction set comprises instructions for controlling functions of the mobile station;
storing a second instruction set in the CPU memory, wherein the second instruction set comprises instructions for controlling the radio portion;
storing a third instruction set in the CPU memory, wherein the third instruction set comprises instructions for controlling at least one external device;
establishing an interface between the mobile device and the at least one external device; and
executing the third instruction set by the CPU, thereby exercising control over the at least one external device.

25. A mobile station, comprising:
a CPU;
a radio portion operably connected to the CPU;
a first CPU memory portion operably connected to the CPU for storing a first instruction set that controls functions of the mobile station;
a second CPU memory portion operably connected to the CPU for storing a second instruction set that controls the radio portion; and
a third CPU memory portion operably connected to the CPU for storing a third instruction set that controls at least one external device,
wherein, during operation, an interface is established between the mobile device and the at least one external device, and
wherein, during operation, the third instruction set is executed by the CPU, thereby exercising control over the at least one external device.

26. A method for using a CPU memory of a mobile station as an interface for a plurality of applications that are external to the mobile station, the method comprising:
storing applications program modules for the external applications in a part of the CPU memory of the mobile station that is available after software that controls conventional functions of the mobile station has been stored; and
interfacing the mobile station and an external device by executing one of the application program modules with the CPU.
